(19) United States
(12) Patent Application Publication
(10) Pub. No.: US 2018/0093535 A1
(43) Pub. Date: Apr. 5, 2018

(54) MOTORCYCLE TIRE

(71) Applicant: BRIDGESTONE CORPORATION, Tokyo (JP)

(72) Inventors: Takahiro DAIRIKI, Tokyo (JP); Dyta ITOI, Tokyo (JP)

(73) Assignee: BRIDGESTONE CORPORATION, Tokyo (JP)

(21) Appl. No.: 15/559,253

(22) PCT Filed: Mar. 16, 2016
(86) PCT No.: PCT/JP2016/058392

§ 371 Date: Sep. 18, 2017

(30) Foreign Application Priority Data
Mar. 20, 2015 (JP) 2015-058787

(51) Int. Cl. B60C 11/13

(52) U.S. Cl. CPC B60C 11/1315; B60C 2011/0376; B60C 2200/10

(57) ABSTRACT

Provided is a motorcycle tire whose wear resistance and drainage performance are improved by refining the tread pattern.

The motorcycle tire includes: a tread section; and side wall sections and bead sections that continuously extend on both sides of the tread section, and the rotation direction of the motorcycle tire when fitted to a motorcycle is designated. In a tread section 10, first inclined main grooves 1 of a linear or curved shape which are inclined with respect to the tire circumferential direction, second inclined main grooves 2 of a linear or curved shape which are inclined in the same direction as the first inclined main grooves 1 but at a different angle, and shallow grooves 3 which are inclined in a different direction from the first inclined main grooves 1 and the second inclined main grooves 2 with respect to the tire circumferential direction are arranged, and the shallow grooves 3 are arranged only in a shoulder part.

### TECHNICAL FIELD

The present invention relates to a motorcycle tire (hereinafter, also simply referred to as “tire”). More particularly, the present invention relates to a motorcycle tire whose wear resistance and drainage performance are improved by refining the tread pattern.

### BACKGROUND ART

Because of the characteristic of two-wheeled vehicles to make turns by tilting the body, which is different from four-wheeled vehicles such as passenger cars and trucks, motorcycle tires have a shape in which the crown section has a smaller curvature and a rounder cross-section than four-wheeled vehicle tires. Therefore, depending on the position of the ground-contacting portion in a ground contact state, the slipping parts in the ground-contacting surface may be uneven particularly when a large driving force is applied, and this is likely to cause uneven wear in which specific parts are rapidly worn out. In such motorcycle tires, a variety of tread patterns are formed by adopting plural combinations of the number and the shape of grooves arranged in the tire tread section so as to improve various tire performances, such as drainage performance in wet conditions and wear resistance.

For instance, Patent Document 1 proposes a motorcycle tire in which thermal degradation of the tread section can be inhibited while maintaining the turning performance and serviceable life (wear resistance) of the tire. In this tire proposed in Patent Document 1, the angle and pitch of the inner-side inclined main grooves arranged at prescribed positions, the inclined narrow grooves arranged between adjacent inner-side inclined main grooves, and the land ratio of the surface in contact with the ground in straight running are adjusted. Further, Patent Document 1 also discloses that the drainage performance can be further improved by adjusting, for example, the land ratio of the tread section, the arrangement pitch of the inner-side inclined main grooves, and the width of the inner-side inclined main grooves.

### RELATED ART DOCUMENT

### Patent Document

Patent Document 1: Japanese Unexamined Patent Application Publication No. 2013-180664

### SUMMARY OF THE INVENTION

### Problems to be Solved by the Invention

Generally speaking, for improvement of the wear resistance of a tire, it is effective to increase the land portion of the tread section; however, the groove ratio in the tread section decreases as the land portion is increased. This makes it difficult to maintain the drainage performance, and it is thus extremely difficult to satisfy both wear resistance and drainage performance. The tire proposed in Patent Document 1 also has these problems and cannot sufficiently comply with the demands of satisfying both wear resistance and drainage performance; therefore, a further improvement in these properties is desired.

In view of the above, an object of the present invention is to provide a motorcycle tire whose wear resistance and drainage performance are improved by refining the tread pattern.

### Means for Solving the Problems

The present inventors intensively studied to solve the above-described problems and consequently discovered that, by allowing inclined main grooves arranged in the tread section to have a prescribed inclination angle and allowing shallow grooves to have a prescribed inclination direction, the wear resistance and the drainage performance can be further improved and the problems can be solved as a result, thereby completing the present invention.

That is, the motorcycle tire of the present invention is a motorcycle tire which comprises: a tread section; and side wall sections and bead sections that continuously extend on both sides of the tread section, and whose rotation direction when fitted to a motorcycle is designated, the motorcycle tire being characterized in that:

in the tread section, first inclined main grooves of a linear or curved shape which are inclined with respect to the tire circumferential direction, second inclined main grooves of a linear or curved shape which are inclined in the same direction as the first inclined main grooves but at a different angle, and shallow grooves which are inclined in a different direction from the first inclined main grooves and the second inclined main grooves with respect to the tire circumferential direction are arranged; and

the shallow grooves are arranged only in a shoulder part.

In the tire of the present invention, it is preferred that the first inclined main grooves and the second inclined main grooves intersect with the shallow grooves. In the tire of the present invention, it is also preferred that the first inclined main grooves and the shallow grooves intersect with each other on the tire width direction outer side relative to the midpoints of the first inclined main grooves in the tire width direction; and that the second inclined main grooves and the shallow grooves intersect with each other on the tire width direction outer side relative to the midpoints of the second inclined main grooves in the tire width direction. Further, in the tire of the present invention, it is preferred that the shallow grooves extend to the tire width direction outer side relative to the tire width direction outer ends of the second inclined main grooves. Still further, in the tire of the present invention, it is preferred that the shallow grooves have a depth of 0.1 to 0.5 mm. The tire of the present invention can be suitably used as a front tire of a motorcycle.

### Effects of the Invention

According to the present invention, a motorcycle tire whose wear resistance and drainage performance are improved by refining the tread pattern can be provided.

### BRIEF DESCRIPTION OF THE DRAWINGS

FIG. 1 is one example of a partial development view illustrating the tread section of a motorcycle tire according to one preferred embodiment of the present invention.

FIG. 2 is one example of a cross-sectional view taken along the width direction of a motorcycle tire according to one preferred embodiment of the present invention.

### MODE FOR CARRYING OUT THE INVENTION

The motorcycle tire of the present invention will now be described in detail referring to the drawings.

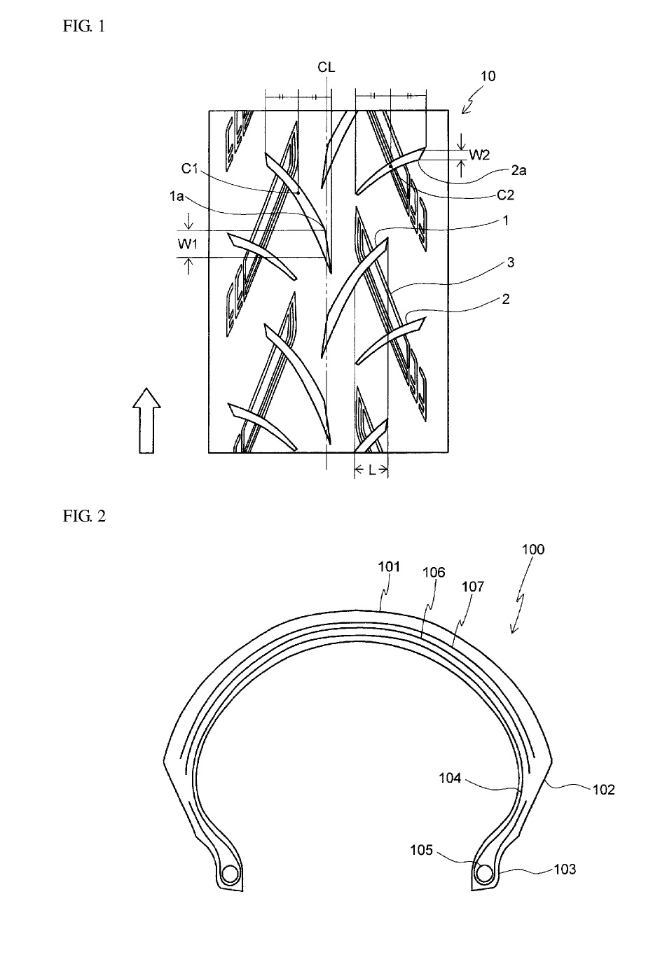

The motorcycle tire of the present invention is a motorcycle tire which comprises: a tread section; and side wall sections and bead sections that continuously extend on both sides of the tread section, and whose rotation direction when fitted to a motorcycle is designated, and the motorcycle tire of the present invention exerts its effects most prominently when used as a front tire. FIG. 1 is one example of a partial development view illustrating the tread section of a motorcycle tire according to one preferred embodiment of the present invention, and the arrow drawn therein represents the rotation direction of the tire.

As illustrated in FIG. 1, in the tire of the present invention, first inclined main grooves 1, which are inclined with respect to the tire circumferential direction, and second inclined main grooves 2, which are inclined in the same direction as the first inclined main grooves 1 but at a different angle, are arranged in a tread section 10. In the illustrated example, the first inclined main grooves 1 are arranged to extend from a central part to a shoulder part, and the second inclined main grooves 2 are arranged in the shoulder part. It is noted here that the term “central part” used herein refers to a region of the tread section 10 that comes into contact with the road surface when the tire is filled with air at a normal inner pressure, a normal load was applied thereto and a motorcycle fitted with the tire is put in a standing position, and the term “shoulder part” used herein refers to the regions of the tread section 10 on both sides of the central part. The inclined main grooves can each have a depth of, for example, 3 to 6 mm at the deepest point.

In the tire of the present invention, the drainage performance is ensured by the first inclined main grooves 1 and the second main inclined grooves 2, and it is preferred that the first inclined main grooves 1 and the second main inclined grooves 2 both have a linear shape or a curved shape. In the illustrated example, the first inclined main grooves 1 and the second main inclined grooves 2 both have a curved shape. The reason for this is because smooth drainage is inhibited when the inclined main grooves have a bending point and, in order to prevent this, in the tire of the present invention, the inclined main grooves are formed in a linear or curved shape with no bending point.

Further, in the tire of the present invention, as illustrated in FIG. 1, shallow grooves 3 (three of them in the illustrated example), which are inclined in a different direction from the first inclined main grooves 1 and the second main inclined grooves 2, are arranged. The drainage performance can be further improved by the shallow grooves 3. The shallow grooves 3 refer to grooves having a depth of 10% or less with respect to the depth of the respective first inclined main grooves 1 and second inclined main grooves 2. Brand-new tires are slippery due to the presence of silicon used in the tire vulcanization process on their surface layers. In addition, it is not preferable to arrange a large number of main grooves in the shoulder part. Therefore, in the tire of the present invention, the initial drainage performance of the shoulder part is improved by arranging the shallow grooves 3 in the shoulder part. Since the rigidity of the central part may be reduced and the wear resistance may thus be deteriorated by arranging the shallow grooves 3 in the central part, in the tire of the present invention, the shallow grooves 3 are arranged only in the shoulder part. In the tire of the present invention, by allowing the shallow grooves 3 to have a depth of 0.1 to 0.5 mm, the drainage performance can be favorably improved while maintaining the rigidity of the tread section.

Further, as described above, the tire of the present invention is suitably used as a front tire, and the inputs to the front tire are braking force and lateral force. Therefore, in order to allow the tire to effectively exert a turning force, it is preferred to arrange grooves in a direction that interferes with the inputs as little as possible, that is, in the direction along the inputs. From this standpoint, it is preferred that the first inclined main grooves 1 and the second main inclined grooves 2 are all configured in a curved shape whose center of the radius of curvature is on the reverse rotation side of the designated tire rotation direction, that is, on the trailing side with respect to the running direction. Moreover, the angle of the shallow grooves 3 is preferably aligned with the normal direction with respect to the direction along the inputs.

In the illustrated example, the first inclined main grooves 1 and the second main inclined grooves 2 are in communication with the shallow grooves 3; however, the tire of the present invention may also take a configuration in which the first inclined main grooves 1 and the second main inclined grooves 2 are not in communication with the shallow grooves 3 and the shallow grooves 3 are arranged between and without intersecting with the respective first inclined main grooves 1 and second inclined main grooves 2. Preferably, the shallow grooves 3 are arranged in such a manner to intersect with the first inclined main grooves 1 and the second main inclined grooves 2. This allows water flowing along the shallow grooves to flow into the inclined main grooves and to be drained from the inclined main grooves, so that the drainage performance can be further improved.

In the tire of the present invention, it is also preferred that the first inclined main grooves 1 and the shallow grooves 3 intersect with each other on the tire width direction outer side relative to the midpoint C1 of each first inclined main groove 1 in the tire width direction; and that the second inclined main grooves 2 and the shallow grooves 3 intersect with each other on the tire width direction outer side relative to the midpoint C2 of each second inclined main groove 2 in the tire width direction. As described above, the shallow grooves 3 are required to be arranged in the shoulder part. In addition, it is preferred that the shallow grooves 3 intersect with the first inclined main grooves 1 and the second inclined main grooves 2. These requirements can be simultaneously satisfied by arranging the shallow grooves 3 in the above-described manner. Moreover, since the ground contact-leading parts of the first inclined main grooves 1 and those of the second inclined main grooves 2 are on the shoulder side, drainage can start at the moment when these parts come into contact with the ground. Taking into consideration the drainage effect of the shoulder part, the shallow grooves 3 preferably extend to the tire width direction outer side relative to the tire width direction outer ends of the second inclined main grooves 2.

Further, in the tire of the present invention, it is preferred that the part of each first inclined main groove 1 where the distance between the groove walls in the tire circumferential direction is the maximum W1 exists on the inner side relative to the midpoint C1 of the first inclined main groove 1 in the tire width direction; and that the part of each second inclined main groove 2 where the distance between the groove walls in the tire circumferential direction is the maximum W2 exists on the outer side relative to the midpoint C2 of the second inclined main groove 2 in the tire width direction. That is, the first inclined main grooves 1 are thicker on the tire width direction inner side, while the second inclined main grooves 2 are thicker on the tire width direction outer side. In the illustrated example, the width of each first inclined main groove 1 gradually decreases toward the outer side in the tire width direction, while the width of each second inclined main groove 2 decreases toward the inner side in the tire width direction.

By making the first inclined main grooves 1 thicker on the tire width direction inner side in this manner, the drainage performance of the central part can be improved, which is effective for inhibiting the hydroplaning phenomenon during high-speed travel. Moreover, by making the second inclined main grooves 2 thicker on the tire width direction outer side, excessive pattern rigidity of the shoulder part can be reduced, so that the wear resistance of the shoulder part can be improved. In order to favorably obtain these effects, the part of each first inclined main groove 1 where the distance between the groove walls in the tire circumferential direction is the maximum is preferably the tire width direction inner end 1a of the groove wall on the rotation-direction leading side of the first inclined main groove 1, and the part of each second inclined main groove 2 where the distance between the groove walls in the tire circumferential direction is the maximum is preferably the tire width direction outer end 2a of the groove wall on the rotation-direction trailing side of the second inclined main groove 2.

Still further, in the tire of the present invention, it is preferred that the first inclined main grooves 1 extend over the tire equator CL. By arranging the first inclined main grooves 1 across the equator CL, the pattern rigidity along the equator CL can be reduced, and this consequently enables to perform steering with a small force. In the illustrated example, the second inclined main grooves 2 do not extend to the central part. The reason for this is because, when the second inclined main grooves 2 extend to the central part, the rigidity of the central part is excessively reduced, and this may lead to deterioration of the wear resistance of the central part.

In the illustrated example, the tire width direction outer ends of the second inclined main grooves 2 are on the outer side relative to the tire width direction outer ends of the first inclined main grooves 1. The reason for this is because, in motorcycles, since turns are made by tilting the motorcycle body at the time of cornering, the shoulder part of the tire comes into contact with the road surface and, when the first inclined main grooves 1 extend to the tire width direction outer side of the tread section 10 further than the second inclined main grooves 2, the shoulder part does not have sufficient rigidity and the cornering performance may thus be impaired. It is noted here that, although the first inclined main grooves 1 are longer than the second inclined main grooves 2, the tire of the present invention is not restricted to this configuration.

Yet still further, in the tire of the present invention, it is preferred that the second inclined main grooves 2 at least partially overlap with the first inclined main grooves 1 in the tire circumferential direction, and the tire width direction length of the region where the first inclined main grooves 1 and the second inclined main grooves 2 overlap with each other (overlapping length L) is preferably 30 to 60% of the length of the first inclined main grooves 1 in the tire circumferential direction. It is noted here that the overlapping length L is the projected length of each inclined main groove in the tire width direction, not the length along each inclined main groove. This configuration enables to set an appropriate distance between the respective first inclined main grooves 1 and second inclined main grooves 2.

That is, when the overlapping length L is greater than 60%, the second inclined main grooves 2 are close to each first inclined main groove 1 on the rotation-direction leading side of the tire and the negative distribution in the width direction is thus uneven (the negative ratio is locally small in the central part or the shoulder part), making it difficult to attain stable wet performance as the camber angle is increased. Meanwhile, when the overlapping length L is less than 30% as well, since the negative ratio is locally small in the tread intermediate region, it is after all difficult to attain stable wet performance as the camber angle is increased.

Furthermore, in the tire of the present invention, it is preferred that the second inclined main grooves 2 are more inclined than the first inclined main grooves 1 with respect to the tire circumferential direction. In motorcycles, since turns are made by tilting the motorcycle body at the time of cornering, the shoulder part of the tire comes into contact with the road surface. Accordingly, during cornering, a force is applied to the shoulder part in a direction close to the tire width direction. Therefore, when the angle of the second inclined main grooves 2 in the shoulder part is close to the tire circumferential direction, the shoulder part is excessively deformed and the driving stability during cornering is thereby reduced. In the tire of the present invention, the angle of the first inclined main grooves 1 with respect to the tire circumferential direction is preferably 20 to 40°, and the angle of the second inclined main grooves 2 with respect to the tire circumferential direction is preferably 40 to 70°. It is noted here that the angle of the first inclined main grooves 1 and that of the second inclined main grooves 2 each refer to an angle formed by a line connecting the centers of the tire width direction ends of the respective grooves and the tire circumferential direction.

In the tire of the present invention, as long as the relationships of the shallow grooves, the first inclined main grooves and the second inclined main grooves satisfy the above-described requirements, there is no other particular restriction. For instance, the shallow grooves 3 illustrated in FIG. 1 play an auxiliary role of the first inclined main grooves 1 and the second inclined main grooves 2 during drainage; however, the shape of the shallow grooves 3 is not particularly restricted. In the illustrated example, the shallow grooves 3 are three grooves that are inclined in the opposite direction of the first inclined main grooves 1 and the second inclined main grooves 2 and have a shape in which both ends of each groove are closed; however, the configuration of the shallow grooves 3 is not restricted thereto. For instance, the shallow grooves 3 may be in the form of a single straight line or a curve line.

FIG. 2 is one example of a cross-sectional view taken along the width direction of a motorcycle tire according to one preferred embodiment of the present invention. As illustrated in FIG. 2, a tire 100 of the present invention comprises: a tread section 101; a pair of side wall sections 102, which continuously extend on both sides of the tread section 101; a pair of bead sections 103, which continuously extend from each of the pair of the side wall sections 102; and a carcass 104, which is composed of at least one carcass ply layer (one carcass ply layers in the illustrated example) reinforcing the above-described sections over the range between the bead sections 103. In the illustrated example, both ends of the carcass 104 are folded around a bead core 105 from the inside to the outside of the tire to be anchored; however, the ends of the carcass 104 may each be sandwiched and anchored by a bead wire.

Further, in the tire illustrated in FIG. 2, a belt layer 106 is arranged on the tire radial direction outer side of the carcass 104. The belt cord of the belt layer 106 is also not particularly restricted, and any known non-extensible high-elasticity cord can be used. For example, an aromatic aramid cord or a steel cord can be suitably used. In the tire 100 illustrated in FIG. 2, a spiral belt layer 107 is further arranged on the tire radial direction outer side of the belt layer 106. This spiral belt layer 107 is formed by spirally winding in the circumferential direction an elongated rubber-coated cord obtained by coating a single cord with rubber or a strip-form ply obtained by coating a plurality of cords with rubber, and the cord(s) can be selected as appropriate from, for example, steel cords, cords made of organic fibers such as aramid (e.g., trade name “Kevlar®” manufactured by DuPont), polyethylene naphthalate (PEN), polyethylene terephthalate (PET), rayon or nylon, and cords made of a material such as glass fiber or carbon fiber.

### EXAMPLES

The present invention will now be described in more detail by way of examples thereof.

### Example 1

A motorcycle tire having a tread pattern of the type illustrated in FIG. 1 was produced at a size of 120/70ZR17M/C. The first inclined main grooves had a shape of being thick on the tire width direction inner side and gradually getting narrower toward the tire width direction outer side, and the second inclined main grooves had a shape of being thick on the tire width direction outer side and gradually getting narrower toward the tire width direction inner side. The shallow grooves had an angle of 20° with respect to the tire circumferential direction, and the points of intersection between the shallow grooves and the first and second inclined main grooves were positioned on the tire width direction outer side by more than ½ of the length of each inclined main groove in the tire width direction. The shallow grooves had a depth of 0.3 mm and were arranged only in the shoulder part.

The maximum distance between the groove walls of each first inclined main groove was set at 14 mm, and the position of this maximum distance between the groove walls of each first inclined main groove was the tire width direction inner end of the groove wall on the rotation direction leading side of the first inclined main groove. Further, the maximum distance between the groove walls of each second inclined main groove was set at 7 mm. The position of this maximum distance between the groove walls of each second inclined main groove was the tire width direction outer end of the groove wall on the rotation direction trailing side of the second inclined main groove. Moreover, the first inclined main grooves were arranged across the tire equator, and the overlapping length L of the first and second inclined main grooves was 45%. The first inclined main grooves had an angle of 30° with respect to the tire circumferential direction, and the second inclined main grooves had an angle of 55° with respect to the tire circumferential direction.

### Example 2

The motorcycle tire of Example 2 was produced in the same manner as in Example 1, except that the shallow grooves did not extend to the tire width direction outer side of the second inclined main grooves.

### Example 3

The motorcycle tire of Example 3 was produced in the same manner as in Example 1, except that the shallow grooves intersected with neither the first inclined main grooves nor the second inclined main grooves.

### Example 4

The motorcycle tire of Example 4 was produced in the same manner as in Example 1, except that the shallow grooves had a depth of 1.0 mm.

### Example 5

The motorcycle tire of Example 5 was produced in the same manner as in Example 1, except that the points of intersection between the shallow grooves and the first and second inclined main grooves were positioned at a distance of ⅗ or greater of the length of the respective first and second inclined main grooves from their width direction outer ends.

### Comparative Example 1

The motorcycle tire of Comparative Example 1 was produced in the same manner as in Example 1, except that the shallow grooves were inclined in the same direction as the first and second inclined main grooves.

### Comparative Example 2

The motorcycle tire of Comparative Example 2 was produced in the same manner as in Example 1, except that the shallow grooves extended to the central part.

The thus obtained tires were each assembled to a wheel having a rim size of MT3.5×17 inches and fitted to a 1,000-cc motorcycle as the front tire at an inner pressure of 250 kPa. As the rear tire, a conventional tire was fitted. This rear tire had a size of 190/55ZR17M/C, a rim size of MT6.0×17 inches and an inner pressure of 290 kPa. This motorcycle was driven on a test track, and the drainage performance of the front tire on wet road and the tire wear resistance were evaluated by the following methods.

### <Wear Resistance of Central Part>

After the completion of the driving test performed by a test rider, the wear amount of each tire was measured using a depth gauge and compared. The results thereof are shown as index values where a value of 100 represents the wear amount of the tire of Comparative Example 1. A larger value indicates superior wear resistance.

### <Drainage Performance>

The strength of the gripping force of each tire on wet road and the change in the gripping strength in response to tilting of the tire were evaluated by the test rider based on the feeling. The results thereof are shown as index values where a value of 100 represents the tire of Comparative Example 1. A larger value indicates superior drainage performance.

TABLE 1

| | Example 1 | Example 2 | Example 3 | Example 4 |
|---|---|---|---|---|
| Match between the inclination | ∘ | ∘ | ∘ | ∘ |
| direction of shallow grooves and | | | | |
| the direction of first and second | | | | |
| inclined main grooves*¹ | | | | |
| Extension of shallow grooves to | ∘ | ∘ | ∘ | ∘ |
| the central part*² | | | | |
| Position of the points of | less than ½ | less than ½ | less than ½ | less than 1/2 |
| intersection between shallow | | | | |
| grooves and first and second | | | | |
| inclined main grooves*³ | | | | |
| Presence or absence of extension | ∘ | x | ∘ | ∘ |
| of shallow grooves to the tire | | | | |
| width direction outer side of | | | | |
| second inclined main grooves | | | | |
| Presence or absence of | ∘ | ∘ | x | ∘ |
| intersection between shallow | | | | |
| grooves and first and second | | | | |
| inclined main grooves | | | | |
| Shallow groove depth (mm) | 0.3 | 0.3 | 0.3 | 1.0 |
| Wear resistance of the central part | 100 | 100 | 100 | 95 |
| (index) | | | | |
| Drainage performance (index) | 110 | 105 | 105 | 110 |

*¹A symbol of “∘” was assigned when the inclination direction of the shallow grooves and that of the first and second inclined main grooves were different, and a symbol of “x” was assigned when these inclination directions were the same.
*²A symbol of “∘” was assigned when the shallow grooves did not extend to the central part, and a symbol of “x” was assigned when the shallow grooves extended to the central part.
*³Indicates the position of the points of intersection between the shallow grooves and the inclined main grooves in terms of the ratio of the width-direction length of the respective inclined main grooves from their tire width direction outer ends.

TABLE 2

| | | Comparative | Comparative |
|---|---|---|---|
| | Example 5 | Example 1 | Example 2 |
| Match between the inclination direction of | ∘ | x | ∘ |
| shallow grooves and the direction of first | | | |
| and second inclined main grooves*¹ | | | |
| Extension of shallow grooves to the central | ∘ | ∘ | x |
| part*² | | | |
| Position of the points of intersection | not less than ⅗ | less than ½ | less than ½ |
| between shallow grooves and first and | | | |
| second inclined main grooves*³ | | | |
| Presence or absence of extension of | ∘ | ∘ | ∘ |
| shallow grooves to the tire width direction | | | |
| outer side of second inclined main grooves | | | |
| Presence or absence of intersection | ∘ | ∘ | ∘ |
| between shallow grooves and first and | | | |
| second inclined main grooves | | | |
| Shallow groove depth (mm) | 0.3 | 0.3 | 0.3 |
| Wear resistance of the central part (index) | 100 | 100 | 85 |
| Drainage performance (index) | 105 | 100 | 110 |

From the above, it is seen that the tire of the present invention has excellent wear resistance and excellent drainage performance.

### DESCRIPTION OF SYMBOLS

1: first inclined main groove
2: second inclined main groove
3: shallow groove
10: tread section
100: motorcycle tire (tire)
101: tread section
102: side wall section
103: bead section
104: carcass
105: bead core
106: belt layer
107: spiral belt layer

1. A motorcycle tire which comprises: a tread section; and side wall sections and bead sections that continuously extend on both sides of said tread section, and whose rotation direction when fitted to a motorcycle is designated, wherein
in said tread section, first inclined main grooves of a linear or curved shape which are inclined with respect to the tire circumferential direction, second inclined main grooves of a linear or curved shape which are inclined in the same direction as said first inclined main grooves but at a different angle, and shallow grooves which are inclined in a different direction from said first inclined main grooves and said second inclined main grooves with respect to the tire circumferential direction are arranged, and
said shallow grooves are arranged only in a shoulder part.

2. The motorcycle tire according to claim 1, wherein said first inclined main grooves and said second inclined main grooves intersect with said shallow grooves.

3. The motorcycle tire according to claim 1, wherein
said first inclined main grooves and said shallow grooves intersect with each other on the tire width direction outer side relative to the midpoints of said first inclined main grooves in the tire width direction, and
said second inclined main grooves and said shallow grooves intersect with each other on the tire width direction outer side relative to the midpoints of said second inclined main grooves in the tire width direction.

4. The motorcycle tire according to claim 1, wherein said shallow grooves extend to the tire width direction outer side relative to the tire width direction outer ends of said second inclined main grooves.

5. The motorcycle tire according to claim 1, wherein said shallow grooves have a depth of 0.1 to 0.5 mm.

6. The motorcycle tire according to claim 1, which is used as a front tire.
